(19) United States
(12) Patent Application Publication
(10) Pub. No.: US 2006/0204641 A1
(43) Pub. Date: Sep. 14, 2006

(54) Add your own oil salad dressing and marinade concentrate.

(76) Inventor: Judy L. Minutella, Rockvale, TN (US)

Correspondence Address: JUDY MINUTELLA, 1524 JARRETT DRIVE, ROCKVALE, TN, 37153, US

(21) Appl. No.: 10/906,913

(22) Filed: Mar. 11, 2005

(51) Int. Cl. A23L 1/221

(52) U.S. Cl. 426/650

(57) ABSTRACT

An Italian style or flavored salad dressing and marinade concentrate in liquid form, which contains no oil. The consumer is at liberty to mix, in a separate container the pre-selected amount of hand-shaken concentrate containing vinegar, salt, water, sugar, herbs and spices with the type and amount of oil of their choosing on a per-use basis and storing the unused liquid concentrate for future use.

### FIELD OF THE INVENTION

This invention relates in general to food products, and in particular to an Italian Flavored oil-free Salad Dressing and Marinade concentrate to which the consumer adds their own oil on a use-by-use basis.

### DESCRIPTION OF RELATED ART

There are aisles of ready-made salad dressings and marinades lining grocery store shelves. Consumers now have choices in flavor and fat content (full fat, low fat and no fat). There is no option as to the type of fat used in these ready-made products, nor can the consumer regulate the amount used in the making of the product. It is a “take it or leave it” market.

Powdered dressing mixes exist but require measuring and mixing at least two additional ingredients to make the final product (i.e.; U.S. Pat. Nos. 5,221,551 and 4,596,715). Once mixed, the consumer now has a full-sized portion of the final product when perhaps only a minimal amount was needed.

No like product is known, however that is packaged and/or sold so the consumer chooses the amount to mix on a per-use basis, opts for the type and amount of oil to add based on taste and/or health preferences, then can store the unused, bottled concentrate for use at another time. This product offers these options and the consumer can adjust the strength or intensity of flavor by adding additional and/or oil to taste on a use-by-use basis. No exact measurements required.

### DETAILED DESCRIPTION OF THE INVENTION

The preferred major ingredients used in making the salad dressing and marinade concentrate are a vinegar base with the addition of filtered or spring water, lemon juice, sugar, salt, herbs and selected seasonings. The process and ingredients are below. It must be recognized however, that the quantities given are for a preferred mixture, but may be varied somewhat according to the desired flavor. The proportions given are relative to each other and if varying the total quantity of the finished product, one must be aware of the necessity to increase or decrease each ingredient proportionately.

In the preferred embodiment, which is for an Italian-flavored vinaigrette dressing and/or marinade in liquid concentrate but which is applicable to many other types of food products, the process is performed as described below.

Using a glass or plastic bottle or container with the cap or lid removed, which also serves as the storage devise for the final product, proceed by:
Step (1) Reconstitute 1-dry weight ounce of dehydrated, minced garlic in a separate small glass cup in 2.5 ounces of filtered, purified or spring water;
Step (2) Using a stainless steel or plastic funnel positioned over the glass or plastic bottle or container, measure and pour 1.33-dry weight oz of sugar into the bottle, preferably refined sugar;
Step (3) Incorporate 0.66-dry weight ounces of salt, preferable iodized table salt;
Step (4) Incorporate 0.166-dry weight ounces of dried, crushed oregano leaves;
Step (5) Incorporate 0.166-dry weight ounces of dried, crushed red pepper flakes;
Step (6) Incorporate 0.083-dry weight ounces of dried, crushed basil leaves;
Step (7) Incorporate 0.0416-dry weight ounces of ground black pepper corns, preferably freshly ground to medium-fine;
Step (8) Incorporate the reconstituted minced garlic described in step (1);
Step (9) Incorporate 8-fluid ounces of vinegar, preferably cider vinegar;
Step (10) Incorporate 4-fluid ounces of filtered, purified or spring water;
Step (11) Incorporate 0.5-fluid ounces of lemon juice, preferably natural strength lemon juice from concentrate;
Step (12) Close the glass or plastic container and vigorously hand shake for at least 10 minutes at room temperature to dissolve the sugar and salt into the mixture;
Step (13) The finished product should be bottled and sealed according to conventional methods. It is then stored at a temperature of 50 degrees to 75 degrees Fahrenheit. Once opened, refrigeration is recommended.

As previously emphasized, a wide number of variables may be adjusted in the ingredients and process above while remaining within the scope of the claims.

In the preferred form, the liquid concentrate is a blend of vinegar, herbs and spices with chunks of garlic.

For use as a salad dressing or marinade, the mixture is shaken vigorously to disburse the herbs and spices, and then an amount chosen by the consumer is poured into another receptacle to which their chosen oil is added. Once shaken again, this oil and concentrate blend is poured over salad (as a dressing) delivering a burst of zesty flavor via the chunks of garlic and spices; or over meat or vegetables (as a marinade) acting as a tenderizer and flavor enhancer.

The concentrate has an appealing and refreshing taste and can be used in a variety of foods. For example, the concentrate can be used in the preparation of other dressings and sauces (e.g., coleslaw, creamy and other dressings for salads, B-B-Q sauce), beans and vegetables (e.g., lima beans, chili, cooked greens), pasta salads, sandwiches, dips and spreads.

What is claimed is:

1. A recipe for an oil free salad dressing and marinade concentrate comprising ingredients combined in proportions substantially including those listed in the following claims.

2. The recipe of claim 1 wherein the vinegar is cider vinegar of no more than 8 fluid ounces.

3. The recipe of claim 1 wherein the water is filtered, purified or spring water of no more than 4 fluid ounces.

4. The recipe of claim 1 wherein the lemon juice is natural strength lemon juice from concentrate of no more than 0.5 fluid ounces.

5. The recipe of claim 1 wherein the Garlic is at least 1 dry weight oz of dehydrated, minced garlic reconstituted in at least 2-3 fluid ounces of filtered, purified or spring water.

6. The recipe of claim 1 wherein the sugar is refined sugar of at least 1.33 dry weight ounces.

7. The recipe of claim 1 wherein the salt is iodized, table salt of at least 0.66 dry weight ounces.

8. The recipe of claim 1 wherein the red pepper is dried crushed, red pepper flakes of at least 0.166 dry weight ounces.

9. The recipe of claim 1 wherein the oregano is dried crushed oregano leaves of at least 0.166 dry weight ounces.

10. The recipe of claim 1 wherein the basil is dried crushed basil leaves of at least 0.083 dry weight ounces.

11. The recipe of claim 1 wherein the pepper is freshly ground dried black peppercorns of at least 0.0416 dry weight ounces.
